(19) United States
(12) Patent Application Publication
(10) Pub. No.: US 2018/0012325 A1
(43) Pub. Date: Jan. 11, 2018

(54) Methods of orchestrating ground to trans-orbital pipelines connecting to orbital freight management hubs to create and sustain any orbital heavy industry.

(71) Applicant: john aylmer, Winter Park, FL (US)

(72) Inventor: John Aylmer, Winter Park, FL (US)

(21) Appl. No.: 15/055,606

(22) Filed: Feb. 28, 2016

Related U.S. Application Data
(63) Continuation of application No. 62/282,148, filed on Jul. 16, 2015, now abandoned.

(51) Int. Cl. G06Q 50/30; B64C 1/22; B64G 1/62; G06Q 10/08

(52) U.S. Cl. CPC G06Q 50/30; G06Q 10/083; B64C 1/22; B64G 1/62

(57) ABSTRACT

At the time of this invention, parallel efforts by military and government agencies in conjunction with the mushrooming commercial space flight industry are reaching for a everyday, reliable, and profitable solution to making Space and Planetary development an advantageous business venture. To date, their solutions still have major shortfalls originating from the missing link of not providing for a highly profitable routine round trip utilizing trans-orbital, extremely heavy-lift freight carrier operation of greater than 60 tons which is modeled after typical air freight operations similar to UPS or FedEx.

### CROSS REFERENCE TO RELATED APPLICATIONS

This application claims are divisional and benefits of U.S. Provisional application Ser. No. 14/998,419 filed on 1 Jan. 2016 and which is hereby incorporated by reference in its entirety; U.S. Provisional Application Ser. No. 62/282,148 filed on 16 Jul. 2015 and which is hereby incorporated by reference in its entirety; 62/176,253 Filed: 12 Feb. 2015

Application No. 62/282,148 Filed: Jul. 16, 2015

### FEDERALLY SPONSORED RESEARCH OR DEVELOPMENT

Does not apply.

### JOINT RESEARCH AGREEMENTS

Does not apply.

### SEQUENCE LISTING

Does not apply.

### STATEMENT REGARDING PRIOR DISCLOSURES

Does not apply.

### FIELD OF THIS INVENTION

This invention is the merging and then changing the paradigm of existing, extensive freight transportation systems with the addition of a fleet of transorbital air freight carriers. The basis of this invention is built upon continuous logistics pipeline having the capability of rapidly expanding into a continuous sustainable flow of products between heavy industrial and commercial ventures for profit and future planetary frontiers.

### BACKGROUND OF INVENTION

At the time of this invention, parallel efforts by military and government agencies with mushrooming commercial space flight industry are reaching for a profitable solution to make Deep Space and Planetary ventures a profitable business. To date, their solutions suffer from major shortfalls originating from a missing link of not providing profitable, routine, transorbital round trip capability with an extremely heavy lift freight carrier operation of greater than 60 tons and modeled after typical air freight operations, similar to freight operations of UPS, FedEx, DHL, et al.

Early attempts to correct this shortfall by creating a trans-orbital transportation pipeline had been introduced by NASA with the Space Shuttle Program. In an 18 Oct. 2005 NASA Shuttle Report, NASA appears to lack a functional carrier adequate to accomplish the full spectrum of NASA mission goals. Up to the time of cancellation of the program, the report showed that NASA goals remain unsustainable because current space activities were constrained by the following:
Operational flexibility and responsiveness: flight rate has not achieved concept goals.
Operated by RDT&E personnel: the agencies (instead of commercial operations personnel) bring resultant high operations costs. There were no reward incentives, or system, to support order-of-magnitude cost cutting.
Limited in-space maneuvering capability: science and logistic mission scopes unable to attain agency vision.
Concern for safety and reliability is constrained to the present system architecture: no way to incorporate needed drastic change.
Significant constraints on payload density and volume: greater operability (flight rate) is needed to reduce historically high Life Cycle Costs (LCC) or $/Payload lb. to orbit/year and provide much larger annual mass-throw capability.
Cancellation of the Space Shuttle Program: many of its tasks are being subcontracted to SPACE-X and other comparable companies.

With NASA's Space Shuttle program canceled, the US Air Force Flight Plan has identified a wide array of different mission gaps to fill. Under the USAF Flight Plan 2014, one such gap is their Vector 4 which establishes and maintains an integrated, strategic approach to meet the Nation's needs for Air Force-provided deterrence and assurance capabilities. The USAF objective goal is to deliver military assets into orbit and/or return with assets to meet their USAF nuclear enterprise (NE) action plans. With successful implementation of this action plan, the USAF NE staff would be able to evaluate and prioritize their requirements to a far greater extent in: 1) improving methods to sustain, modify and deploy new space weapons and intelligent systems, 2) constructing spacecraft debris collectors to capture and then return space junk, and 3) providing a method of building and upgrading space complexes supporting nuclear deterrence operations (NDO) or other Joint operations. The USAF NE gap is traced to a lack of a routine round trip trans-orbital extremely heavy freight carrier operation.

As we examine the current recreation and business space industry, the FAA is establishing new regulations and policies for a fledgling industry which is developing a mixture of sub-orbital approaches of a circa 1960 genre. Currently, the FAA classified these approaches as sub-orbital reusable vehicles (SRVs) which will pioneer a new low orbit spaceflight industry. SRVs are commercially developed reusable space vehicles that might carry a very limited amount of either humans or cargo. The companies developing these vehicles typically target high flight rates and relatively low costs as compared to NASA or DOD launch. SRVs capable of carrying humans are in development or planning phase for operations over the next few years. Several of these SRV carriers have limited operational capabilities with increases planned by private investors who need to turn a quick profit.

A recent FAA study forecasts a 10-year demand for suborbital reusable vehicles. The goal of their studies have been to provide information to government and industry decision makers on the emerging SRV market by analyzing market dynamics, especially areas of uncertainty and lack of awareness of SRV capabilities. The study was jointly funded by the Federal Aviation Administration Office of Commercial Space Transportation (FAA/AST)and Space Florida.

The expansion into space development is hindered by continued growing military budget shortfalls while at the same time so many commercial enterprises have diverse spacecraft and approaches being explored. This fledging commercial space industry lacks a singularity. Until focused on one all-encompassing mission that provides a solution for both military and commercial ventures, the attainment of this singularity could remain challenging for decades if the existing paradigm of disparate systems is not broken and a innovative paradigm is not initiated to provide extreme heavy lift capabilities of greater than 60 tons to provide for new, profitable space ventures.

### DETAILED DESCRIPTION OF THE INVENTION

The method of the present invention is comprised of three integrated freight shipping systems with their tracking systems to create and evolve into a perpetual and finitely scheduled transorbital transportation pipeline FIG. 3 and FIG. 4 for the primary purpose of changing the space paradigm to create and sustain a ‘for-profit’ heavy industry and commercial destination with a return to earth with manufactured goods.

This present invention embraces three embodiments that are integrated to form the entire transportation pipeline system which enables continuous manufacturing in orbit. Functioning as a system takes on board the (a) utilization of existing in-situ ground transportation's system computer networks, freight hubs and resources; (b) it will introduce and require sustainment of a dedicated fleet of transorbital freight carriers, orbital computer networks and resources; and (c) it will introduce and require sustainment of orbital freight hub destinations required to enable continue future grow ‘for-profit’ heavy industry destinations and a military posture.

With the first embodiment of his present invention, makes full utilization of existing in-situ ground freight transportation systems that has already capitalized on the engineering proficiency coupled with the vast resources of existing freight carrier corporations. These corporations can provide two essential capabilities (a) provide rapid and timing deliveries between all project suppliers and manufacturers supplies components for an orbital build FIG. 1; (b) to meet the strict timing requirements of preparing manufacturers' components for delivery; transportation and delivery of these components to the final ground destination at the freight hub at transorbital airport FIG. 2; and (c) turn over components and cargo manifests to the loadmaster of transorbital freight aircraft FIG. 3. By utilization and contracting of these mega freight carrier corporations, this invention embraces their use of their own patents U.S. Pat. No. 7,761,348 B2; CA 2,550,852 A1; U.S. Pat. No. 7,293,707 B2; U.S. Pat. No. 6,266,008 B1, and other related patents for freight movement and inventory.

The second embodiment introduces and requires sustainment of a dedicated fleet of transorbital freight carriers nomenclatured the “Prime Mover, simply Mover” 26 filed under patent application 62/176,253 on Mar. 16, 2015. The principal “Mover” design requirements are that it (a) can take off and land at an 8,000+ foot commercial runaway; (b) fly within FAA flight and weather regulations; (c) maximize the use of existing readily available technicians, software, and components—such as simulators, jet engines and rockets; (d) reconfigured for orbital insertion or returning earth; (e) sustain a rigorous maintenance schedule; (f) carrying approximately 60+ tons of cargo and passengers; and the fleet can maintain a finite fly schedule of 24/7 365 to the designated freight hub destinations.

As the second embodiment ends at the transportation pipeline terminal end point for the orbital off loading cargo 33. Upon a “Movers” scheduled arrival at the designated orbital location, the third embodiment begins with remotely controlled robot materials handling devices exacting a carrier's cargo then floats them to the assemblage area 34. Under this inventions' third embodiment, the assemblage of the first freight handling facility 40 will be constructed, tested and made operational into the initial freight destination. Once operational, this small hub will have a dual function of receiving cargo and training of robotic material handling and robotic assemblage. The methods of construction and making this smaller facility 40 into a massive operational complex 41 has been filed under patent application 62/176,253 on Mar. 16, 2015.

As this third embodiment continues, a fleet of Movers on a finite arrival schedule following an orchestrated off-loading sequence will bring building components, outfitting equipment and raw materials FIG. 5 anything required to complete and make operational the first freight hub destination FIG. 4. This freight hub will have the additional capabilities of being an industrial park and building modules that become larger complexes.

The third embodiment ends with the construction completed and transorbital transportation pipeline fright hub 41 becomes operational. However, this methods and embodiments of this inventions is continuous and will be ever evolving has heavy industry expands. Although the narrative of this invention has described a one way event, this fully operational orbital freight hub having continuous arrival and departures the ‘Mover’ operations becomes airport terminal destination. Just like a terrestrial airport, massive amounts of cargo and passengers will pass daily through these portals. Without a focused, aggressive and enmasse' undertaking of this patents and the other related patents, the daily profitable of having heavy industrialization and commercialization of space, including a survivable planetary habitable environment remains challenged with the desired continuation use of 1962.

### DESCRIPTIONS OF THE DRAWINGS (5)

FIG. 1: Functional Logic Flow Diagram depicting the ‘Informational Architect Description’ to manage the transportation pipeline system

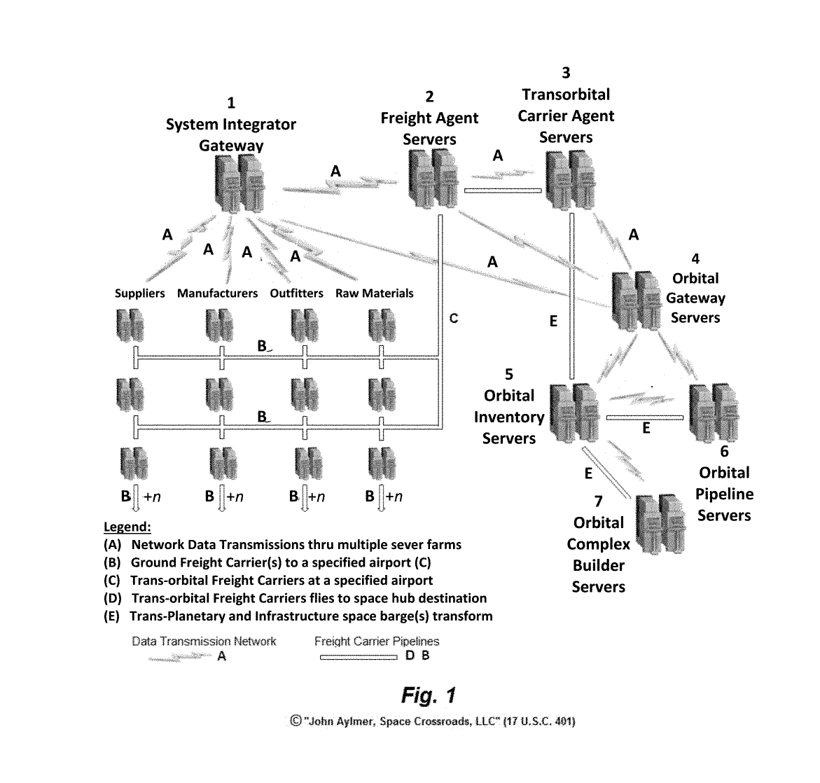

FIG. 2: Task Flow Diagram implementing FIG. 1 of major tasks from a manufacturer to the orbiting freight hub.

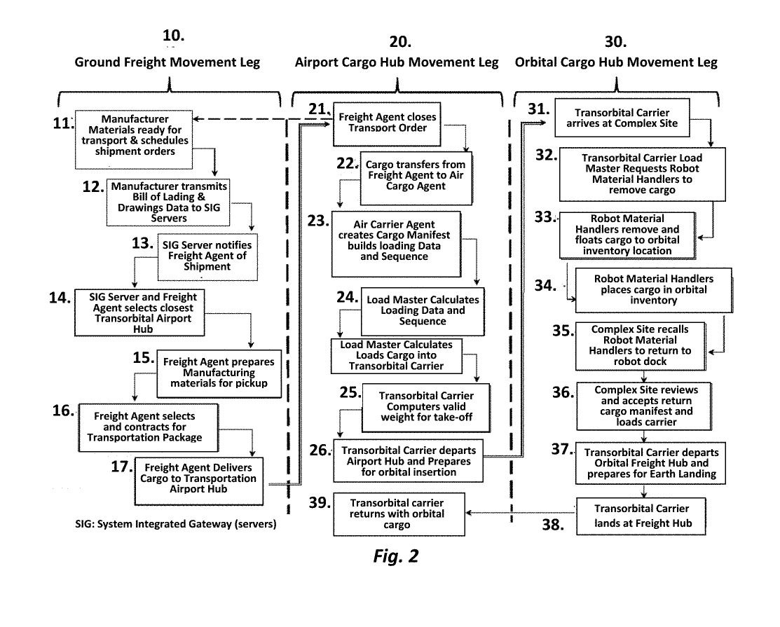

FIG. 3: Material Flow Diagram implementing FIG. 2 moving materials from manufacturer to a typical terrestrial freight hub runway for transport.

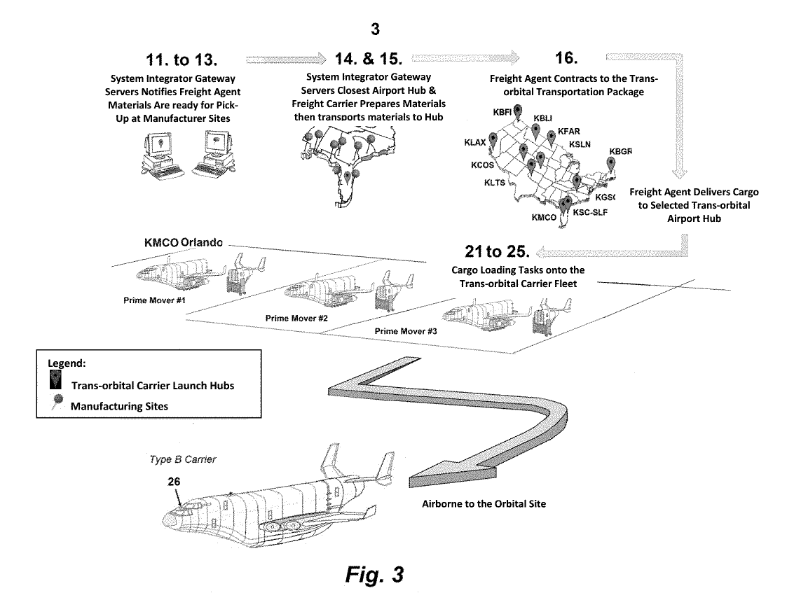

FIG. 4: Material Flow Diagram delivery of materials to the final orbital freight hub which then floats materials the robotic modular assemblage to build facilities.

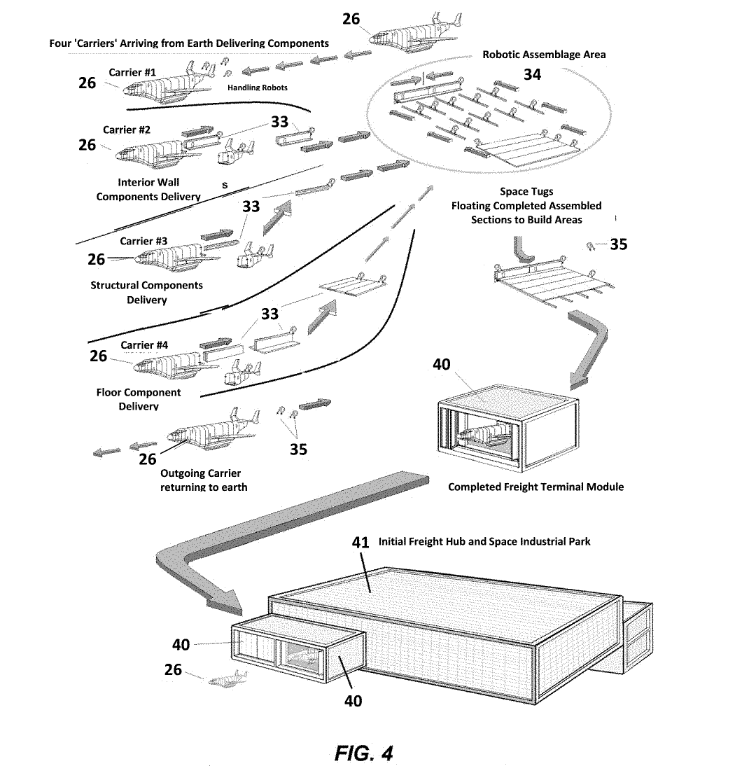

FIG. 5: Isometric views of showing various mixtures of open cargo 44, intermodals 45 and passengers intermodals 42 that could be in a transorbital freight carrier 3

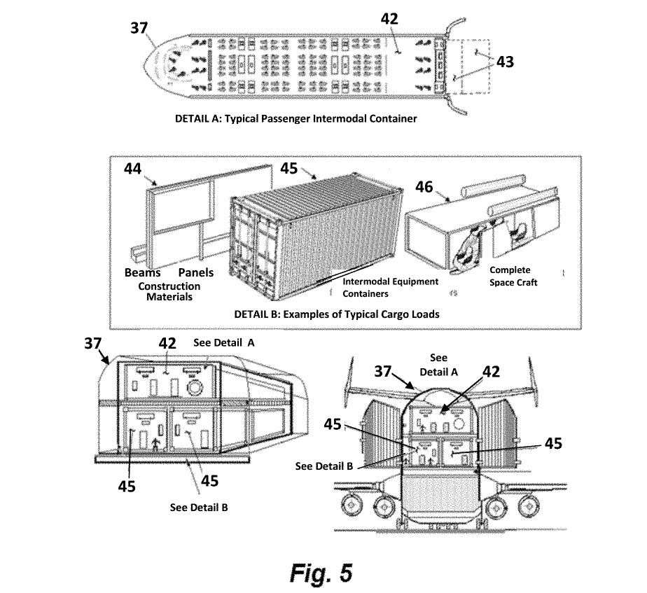

What is a claimed is:

1) A method of operation for a project system integrator 1 using an internet network system applying commercially available software with anticipated modifications to coordinate and share information regarding the finite delivery schedules and transportation modes that is between:
Each contributing project supplier servers;
Freight agent servers 2 for delivery of components;
Transorbital carrier agent servers 3 at each airport freight hubs.

2) A continuation of claim 1, a method of operation for a project system integrator 1 and freight carrier 3 using an internet network system to coordinate predetermined ground or air freight shipments between each supplier and/or bring transorbital cargo shipments directly to a [specific] airport hub.

3) A continuation of claim 1, a method of operation of a project system integrator 1, to coordinate predetermined cargo movements amongst freight carriers, transorbital carriers 3 and the project complex builder 5 passing information and data internet [with ] the orbital network system server farms.

4) A system for efficiently handling shipments using project and inventory management software with anticipated modifications to graphically inform and provide comprehensive details in near real time about the health and performance of all ground movement resources 10, 20 to move inventoried cargo from a manufacturer 11 to the awaiting transorbital freight carrier.

5) A continuation of claim 4, system for efficiently handling orbital shipments from arriving transorbital freight carrier aircraft 32 at a orbital receiving facility which employs material handling robots to extract 33 cargo and place cargo into inventory 34 to assembly an orbital freight hub complex 40, 41.

6) A continuation of claim 5, A device that is a transorbital freight carrier aircraft 32 comprising of two partitions with the upper partition used by the flight crew and cargo while the lower partition will house two different propulsion systems, two different fuel systems, hydraulic systems and a robust landing gear systems providing a method to lift afloat approximately 60 tons or greater of cargo and passengers for insertion into deep space with the capability to return to earth for a controlled safe landing to an assigned terrestrial airstrip. The Strategic Transorbital Freight Carrier, nomenclatured as a Carrier under patent application No. 62/176,253, dated Feb. 12, 2015, which would have the capabilities to provide for:
An array of bulk and palletized cargo approximating 60 tons or greater that can be easily rolled into position and locked down in the cargo area for transorbital and return shipment.
A plurality of intermodal containers of designs, shapes, dimensions, types and contents that are determined by a builder with direct participation with owner or defined by a mission profile. Intermodal designs are infinite where its uses could be outfitted for either human or cargo, or used a planetary facility.
A intermodal containers could be placed on either the first and/or second floor level of a Carrier as delegated by the loadmaster.
Intermodal containers and all cargo to be loaded and unloaded from two (2) different locations at the rear of a Carrier under the direction of a load master employing Materials Handling Robots for cargo extraction.
While in space that all cargo and intermodals being removed or place in a Carrier are to be handled and managed either by remote or human controlled space tugs bringing these items to the in-situ location.
